(19) United States
(12) Patent Application Publication
(10) Pub. No.: US 2026/0183705 A1
(43) Pub. Date: Jul. 2, 2026

(54) HUMIDITY CONDITIONING MEMBER AND PACKED HUMIDITY CONDITIONING MEMBER

(71) Applicant: SHARP KABUSHIKI KAISHA, Sakai City, Osaka (JP)

(72) Inventors: SHO OCHI, Sakai City, Osaka (JP); TSUYOSHI KAMADA, Sakai City, Osaka (JP); MASAKAZU KAMURA, Sakai City, Osaka (JP); TOSHIYUKI NOBUOKA, Sakai City, Osaka (JP)

(21) Appl. No.: 19/130,717

(22) PCT Filed: Nov. 7, 2023
(86) PCT No.: PCT/JP2023/039957

§ 371 Date: May 16, 2025

(30) Foreign Application Priority Data
Nov. 17, 2022 (JP) 2022-183764

(51) Int. Cl. B01D 53/28; B01D 53/26

(52) U.S. Cl. CPC B01D 53/28; B01D 53/261; B01D 2253/106; B01D 2253/11; B01D 2253/112; B01D 2253/202; B01D 2257/80

(57) ABSTRACT

A humidity conditioning member includes: a plurality of humidity conditioning elements having a surface and containing a liquid either absorbing or releasing water; and a plurality of dispersing elements having an average particle size smaller than an average particle size of the plurality of humidity conditioning elements, adhering to the surface, adsorbing a portion of the liquid from the surface, and dispersing the plurality of humidity conditioning elements.

### TECHNICAL FIELD

The present disclosure relates to a humidity conditioning member and a packed humidity conditioning member. The present application claims priority from Japanese Patent Application JP2022-183764 filed on Nov. 17, 2022, the content of which is hereby incorporated by reference into this application.

### BACKGROUND ART

Patent Document 1 discloses an anti-clumping agent. The anti-clumping agent is made of silica gel fine powder having an average particle size of 5 to 100 nm. The anti-clumping agent is added to a powdery or particulate aromatic compound. This anti-clumping agent can prevent the powdery or particulate aromatic compound from clumping together (see paragraphs [0005] and [0006]).

### CITATION LIST

### Patent Literature

[Patent Document 1] Japanese Unexamined Patent Application Publication No. 2000-087005

### SUMMARY OF INVENTION

### Technical Problems

A humidity conditioning material either dissolves water in the atmosphere into the humidity conditioning material to absorb water or vaporizes the water vapor into the atmosphere to release the water from the humidity conditioning material, so as to condition humidity in the ambient air. The humidity conditioning material exhibits a significant water variation rate at a predetermined humidity. That is why the humidity conditioning material excels in maintaining the humidity at a target (a target humidity). Compared with a humidity conditioning material that physically or chemically adsorbs water vapor into holes, such a humidity conditioning material absorbs or releases moisture in larger amount. The humidity conditioning material typically contains a liquid made of a humidity conditioning component and water. If the humidity conditioning material contain only a small amount of water in order to adjust the ambient air at low humidity, a surface of the humidity conditioning material has strong adhesion. Hence, humidity conditioning materials adhere either to themselves or to an ambient substance, and have no fluidity. Hence, it is difficult to give the humidity conditioning material a secondary treatment such as filling processing of the packing material. Whereas, if the humidity conditioning material contains a large amount of water because the humidity conditioning material has absorbed a large amount of water or is to adjust the ambient air at high humidity, the surface of the humidity conditioning material contains a lot of water and has weak adhesion because the surface is fluid. Hence, it is easy to give the humidity conditioning material the secondary treatment described above. However, the fluid could seep out of the humidity conditioning material, and the packing material that packs the humidity conditioning material might leak the fluid outside. The anti-clumping agent disclosed in Patent Document 1 prevents a powdery or particulate aromatic compound from clumping together such that fluidity of the aromatic compound can improve. However, it is difficult for the anti-clumping agent to simultaneously improve fluidity of a humidity conditioning material that contains a humidity conditioning component and water and prevent the liquid from seeping out of the humidity conditioning material.

The present disclosure is devised in view of the above problem. An aspect of the present disclosure sets out to solve a problem caused by, for example, a liquid found on a surface of a humidity conditioning element and to provide a highly fluid humidity conditioning member that keeps the liquid from seeping out of the humidity conditioning member, and a packed humidity conditioning member.

### Solution to Problem

A humidity conditioning member according to a first aspect of the present disclosure includes: a plurality of humidity conditioning elements having a surface and containing a liquid either absorbing or releasing water; and a plurality of dispersing elements having an average particle size smaller than an average particle size of the plurality of humidity conditioning elements, adhering to the surface, and adsorbing a portion of the liquid from the surface.

A packed humidity conditioning member according to a second aspect of the present disclosure includes: the humidity conditioning member according to the first aspect of the present disclosure; and a packing material packaging the humidity conditioning member and being breathable.

### BRIEF DESCRIPTION OF DRAWINGS

FIG. 1 is a cross-sectional view schematically illustrating a humidity conditioning member of a first embodiment.

FIG. 2 is a cross-sectional view schematically illustrating the humidity conditioning member of the first embodiment if dispersing elements are made of silas (volcanic ash) balloons.

FIG. 3 is an image of a prototype humidity conditioning member of the first embodiment if the humidity conditioning elements have a target humidity of 45% RH and the dispersing elements are made of silas balloons.

FIG. 4 is an image of the prototype humidity conditioning member of the first embodiment if the humidity conditioning elements have a target humidity of 90% RH and the dispersing elements are made of silas balloons.

FIG. 5 is a cross-sectional view schematically illustrating the humidity conditioning member of the first embodiment if the dispersing elements are made of a silicate mineral.

FIG. 6 is a perspective view schematically illustrating a smectite before swelling. The smectite is an example of the silicate mineral forming the dispersing elements included in the humidity conditioning member of the first embodiment.

FIG. 7 is a perspective view schematically illustrating a smectite after swelling. The smectite is an example of the silicate mineral forming the dispersing elements included in the humidity conditioning member of the first embodiment.

FIG. 8 is a cross-sectional view schematically illustrating humidity conditioning elements included in the humidity conditioning member of the first embodiment.

FIG. 9 is a graph showing an example of a moisture absorption isotherm of a water absorbent made of sodium polyacrylate and humidity conditioning elements including a humidity conditioning component made of glycerin.

FIG. 10 is an image showing how to evaluate adhesion of Samples 1 to 6.

FIG. 11 is an image showing how to evaluate adhesion of Samples 1 to 6.

FIG. 12 is an image showing how to evaluate dispersion of Samples 1 to 6.

FIG. 13 is an image showing how to evaluate dispersion of Samples 1 to 6.

FIG. 14 is an image showing how to evaluate presence or absence of a liquid seeping out of Samples 1 to 5.

FIG. 15 is an image showing how to evaluate presence or absence of the liquid seeping out of Samples 1 to 5.

FIG. 16 is a graph showing an increase in weight of water-absorbing paper since before bags that contain Samples 1 to 5 are put still on the water-absorbing paper.

FIG. 17 is a graph showing humidity conditioning speeds of Samples 1 to 4.

FIG. 18 illustrates components of a humidity conditioning member of a second embodiment.

FIG. 19 is a cross-sectional view schematically illustrating a packed humidity conditioning member in a first example of a third embodiment.

FIG. 20 is a cross-sectional view schematically illustrating a packed humidity conditioning member in a second example of the third embodiment.

FIG. 21 is a cross-sectional view schematically illustrating a packed humidity conditioning member of a fourth embodiment.

FIG. 22 shows color change of an indication label included in the packed humidity conditioning member of the fourth embodiment.

FIG. 23 is an image of a prototype humidity conditioning member in a first reference.

FIG. 24 is a cross-sectional view schematically illustrating a packed humidity conditioning member including the humidity conditioning member in the first reference.

FIG. 25 is an image of a prototype humidity conditioning member in a second reference.

FIG. 26 is a cross-sectional view schematically illustrating a packed humidity conditioning member including the humidity conditioning member in the second reference.

### DESCRIPTION OF EMBODIMENTS

Embodiments of the present disclosure will be described below with reference to the drawings. Note that, throughout the drawings, like reference signs denote identical or similar constituent features. Such features will not be repeatedly elaborated upon.

### 1. First Reference

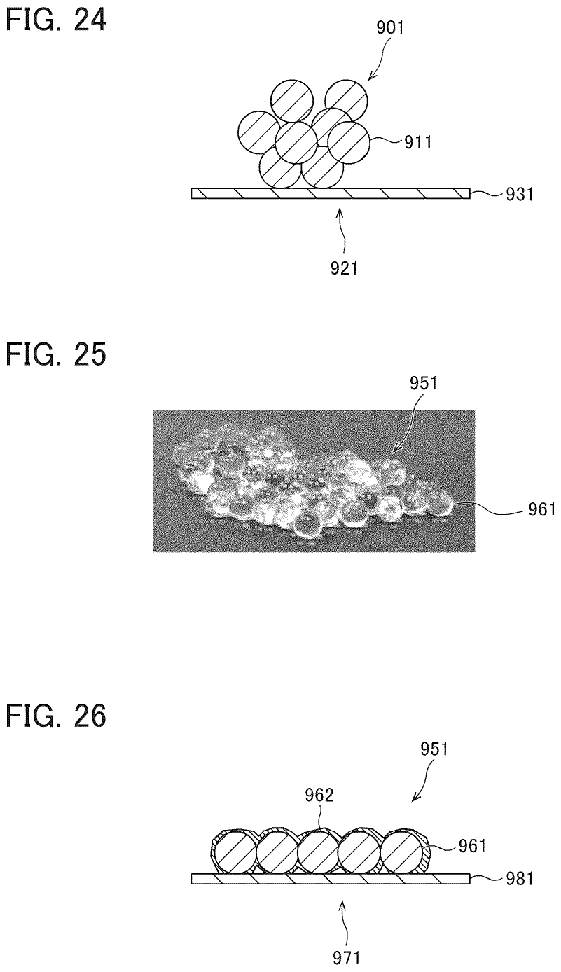

FIG. 23 is an image of a prototype humidity conditioning member in a first reference. FIG. 24 is a cross-sectional view schematically illustrating a packed humidity conditioning member including the humidity conditioning member in the first reference.

As shown in FIGS. 23 and 24, a humidity conditioning member 901 in the first reference includes a plurality of humidity conditioning beads 911. FIG. 24 shows that the humidity conditioning member 901 in the first reference is included in a packed humidity conditioning member 921. The packed humidity conditioning member 921 includes a packing material 931.

The humidity conditioning beads 911 contain a liquid made of a humidity conditioning component and water. The humidity conditioning beads 911 function to adjust a relative humidity of the ambient air to an equilibrium humidity of the humidity conditioning beads 911. Hence, the equilibrium humidity is a target humidity of the humidity conditioning beads 911. The humidity conditioning beads 911 absorb water from the ambient air if the relative humidity of the ambient air is higher than the target humidity of the humidity conditioning beads 911, and release the water into the ambient air if the relative humidity of the ambient air is lower than the target humidity of the humidity conditioning beads 911. The humidity conditioning beads 911 have a target humidity of as low as 40% RH. The packing material 931 packages the humidity conditioning beads 911. The packing material 931 is shaped into a bag. The packing material 931 is made of either a nonwoven fabric or a permeable film.

On a surface of the humidity conditioning beads 911, the liquid made of the humidity conditioning component and water is found. If the humidity conditioning beads 11 have a target humidity of as low as approximately 40% RH, only a small amount of water is found on the surface of the humidity conditioning beads 911. Hence, the liquid found on the surface of the humidity conditioning beads 911 contains the humidity conditioning component at high concentration and has high viscosity. Thus, the humidity conditioning beads 911 adhere securely to one another or to an object around the humidity conditioning beads 911. As a result, the humidity conditioning beads 911 aggregate together to have only low fluidity. That is why, when the plurality of humidity conditioning beads 911 is actually used as a humidity conditioning material, it is difficult to give the plurality of humidity conditioning beads 911 a secondary treatment such as packaging the plurality of humidity conditioning beads 911 into a breathable packing material using such an apparatus as an automated filling and packaging apparatus.

### 2. Second Reference

FIG. 25 is an image of a prototype humidity conditioning member in a second reference. FIG. 26 is a cross-sectional view schematically illustrating a packed humidity conditioning member including the humidity conditioning member in the second reference.

As shown in FIGS. 25 and 26, a humidity conditioning member 951 in the second reference includes a plurality of humidity conditioning beads 961. FIG. 26 shows that the humidity conditioning member 951 in the second reference is included in a packed humidity conditioning member 971. The packed humidity conditioning member 971 includes a packing material 981.

The humidity conditioning beads 961 contain a liquid made of a humidity conditioning component and a larger amount of water. The humidity conditioning beads 961 absorb water from the ambient air if the relative humidity of the ambient air is higher than the target humidity of the humidity conditioning beads 961, and release the water into the ambient air if the relative humidity of the ambient air is lower than the target humidity of the humidity conditioning beads 961. The humidity conditioning beads 961 have a target humidity of as high as 90% RH. The packing material 981 packages the humidity conditioning beads 961. The packing material 981 is shaped into a bag. The packing material 981 is made of either a nonwoven fabric or a permeable film.

On a surface of the humidity conditioning beads 961, a liquid 962 made of a humidity conditioning component and a larger amount water is found. If the humidity conditioning beads 961 have a target humidity of as high as approximately 90% RH, a large amount of water is found on the surface of the humidity conditioning beads 911. Hence, the liquid 962 found on the surface of the humidity conditioning beads 961 contains the humidity conditioning component at low concentration and has low viscosity. Thus, the humidity conditioning beads 911 adhere only poorly to one another or to an object around the humidity conditioning beads 911. As a result, the humidity conditioning beads 911 do not aggregate together to have high fluidity. That is why, it is easy to give the humidity conditioning beads 911 a secondary treatment such as packaging the humidity conditioning beads 911 into a breathable packing material using such an apparatus as an automated filling and packaging apparatus. However, the liquid 962 seeps out of the humidity conditioning beads 961. Hence, the packing material 981 leaks the liquid 962. The leaked liquid 962 could adhere to an object to be stored together with the packed humidity conditioning member 921.

### 3 First Embodiment

### 3.1 Humidity Conditioning Member

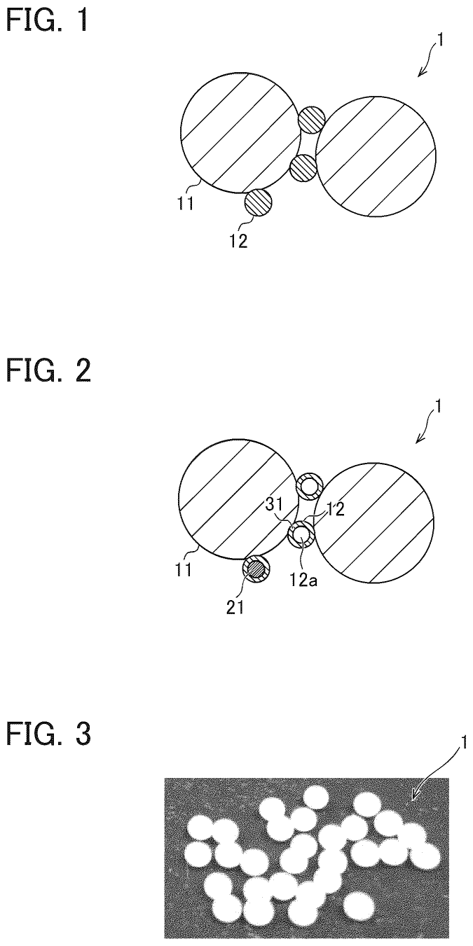

FIG. 1 is a cross-sectional view schematically illustrating a humidity conditioning member of a first embodiment.

Unlike the humidity conditioning member 901 of the first reference and the humidity conditioning member 951 of the second reference, a humidity conditioning member 1 of the first embodiment illustrated in FIG. 1 neither aggregates together nor leaks a liquid.

As illustrated in FIG. 1, the humidity conditioning member 1 includes: a plurality of humidity conditioning elements 11; and a plurality of dispersing elements 12. The humidity conditioning elements 11 are also referred to as, for example, a humidity conditioning material. The dispersing elements 12 are also referred to as, for example, a dispersing material.

### 3.2 Humidity Conditioning Elements

The humidity conditioning elements 11 are powdery, granular, or particulate. The humidity conditioning elements 11 have an average particle size of desirably 0.1 mm or more and 10 mm or less. Here, the average particle size is a value converted into an average spherical diameter. Each of the humidity conditioning elements 11 is a humidity conditioning bead having, for example, a spherical shape and a diameter of 3 mm or more and 6 mm or less.

The humidity conditioning elements 11 have water absorbency. Hence, the humidity conditioning elements 11 can contain water.

The humidity conditioning elements 11 contain a liquid either absorbing or releasing water. Hence, the humidity conditioning elements 11 are capable of conditioning humidity. Thus, the humidity conditioning elements 11 absorb water from the ambient air if the relative humidity of the ambient air is higher than the target humidity of the humidity conditioning elements 11, and release the water into the ambient air if the relative humidity of the ambient air is lower than the target humidity of the humidity conditioning elements 11. Compared with a desiccant represented by the A-type silica gel, the humidity conditioning elements 11 can desorb water when heated at relatively low temperature. Furthermore, the humidity conditioning elements 11 can repeatedly absorb and release water. Hence, in principle, the humidity conditioning elements 11 can have humidity conditioning capabilities on a semipermanent basis. The target humidity of the humidity conditioning elements 11 can be controlled with a material contained in the humidity conditioning elements 11.

### 3.3 Dispersing Elements

The dispersing elements 12 are fine-particulate. The dispersing elements 12 have an average particle size smaller than the average particle size of the humidity conditioning elements 11; that is, desirably, an average particle size of desirably 1 μm or more and 100 μm or less. Here, the average particle size can be represented by the median size D50 measured by, for example, laser diffraction/scattering.

The dispersing elements 12 adhere to the surface of the humidity conditioning elements 11. Hence, the dispersing elements 12 adsorb, from the surface of the humidity conditioning elements 11, a portion of the liquid contained in the humidity conditioning elements 11. Here, the statement “adsorb . . . a portion of the liquid” means that the liquid is adsorbed and confined into the dispersing elements or holes, or between crystal layers, such that surface properties that the dispersing elements originally have are left even a few and that the surface of the dispersing elements is not covered at least with the liquid. The liquid to be adsorbed contains a humidity conditioning component and water. Viscosity of the liquid increases as concentration of the humidity conditioning component increases.

After adsorbing the liquid, the dispersing elements 12 do not adhere or stick together because the surface properties that the dispersing elements 12 originally have are left even a few. Hence, after adsorbing the liquid, the dispersing elements 12 do not aggregate together but disperse away.

Thus, the dispersing elements 12 keep the humidity conditioning elements 11 from sticking together. As a result, the dispersing elements 12 disperse the humidity conditioning elements 11 and keep the humidity conditioning elements 11 from aggregating together.

Furthermore, the dispersing elements 12 enhance capabilities of the humidity conditioning member 1 to hold water or the liquid. Hence, the dispersing elements 12 can keep the liquid from seeping out of the humidity conditioning member 1. Thus, when the humidity conditioning member 1 is packaged with a packing material, the dispersing elements 12 can reduce the risk that the packing material might leak the liquid.

The dispersing elements 12 are chemically stable to the humidity conditioning component contained in the humidity conditioning elements 11. The dispersing elements 12 are highly safe.

For example, the dispersing elements 12 contain at least one selected from the group consisting of porous silica gel, zeolite, silica powder, silas (volcanic ash), a silicic acid compound that contains a silicate mineral (a clay mineral), activated clay, and acid clay. Desirably, the dispersing elements 12 contain at least one selected from the group consisting of silica powder, a material that contains silicon dioxide such as silas, and a silicate mineral. More desirably, the dispersing elements 12 contain at least one selected from the group consisting of silas and a silicate mineral. Silas may be silas balloons.

A main component of silas is silicic acid (silica).

Each of the silas balloons is formed of silas. Silas is treated with heat to foam, and forms the silas balloons each having a hollow structure. A principal ingredient of the silas balloons is hollow silica.

The dispersing elements 12 may be added in a small amount with respect to the humidity conditioning elements 11.

The humidity conditioning member 1 can be produced of the humidity conditioning elements 11 and the dispersing elements 12 mixed together with, for example, a blender.

### 3.4 Dispersing Elements Made of Silas Balloons

FIG. 2 is a cross-sectional view schematically illustrating the humidity conditioning member of the first embodiment if dispersing elements are made of silas balloons.

As illustrated in FIG. 2, if the dispersing elements 12 are made of silas balloons, each of the dispersing elements 12 has a hollow structure. Hence, each dispersing element 12 has a hole 12a formed inside the dispersing element 12. Thus, each dispersing element 12 can draw a liquid 21, adsorbed from the surface of the humidity conditioning elements 11, into the inside of the hole 12a. Even after the liquid 21 is drawn into the inside of the hole 12a, an outer shell 31 made of silica and surrounding the hole 12a maintains the surface properties that the dispersing element 12 originally has. Hence, the outer shells 31 do not aggregate together.

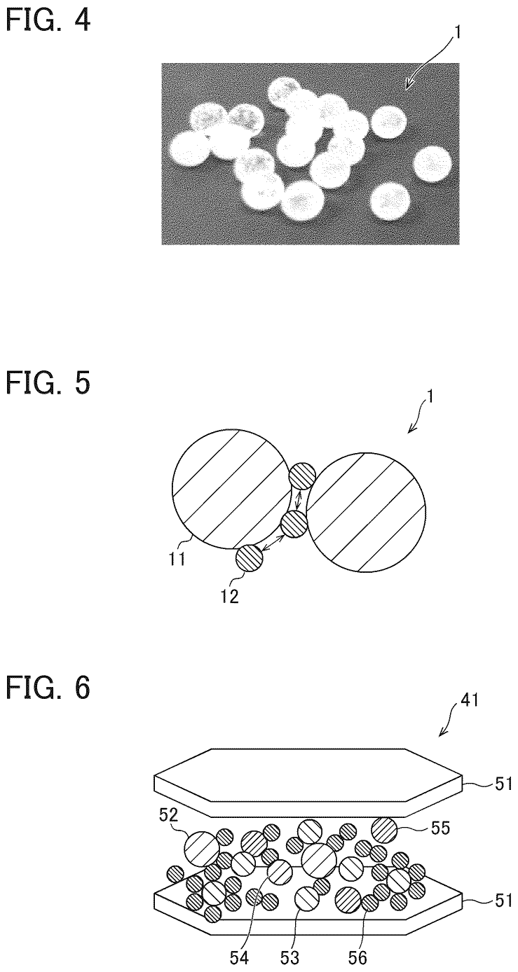

FIG. 3 is an image of a prototype humidity conditioning member of the first embodiment if the humidity conditioning elements have a target humidity of 45% RH and the dispersing elements are made of silas balloons. FIG. 4 is an image of a prototype humidity conditioning member of the first embodiment if the humidity conditioning elements have a target humidity of 90% RH and the dispersing elements are made of silas balloons.

As shown in FIGS. 3 and 4, even if the humidity conditioning elements 11 have a target humidity of either 45% RH or 90% RH, when the dispersing elements 12 are made of silas balloons, the humidity conditioning member 1 does not stick together and rolls individually. This means that the silas balloons can keep the humidity conditioning member 1 from aggregating together.

### 3.5 Dispersing Elements Made of Silicate Mineral

FIG. 5 is a cross-sectional view schematically illustrating the humidity conditioning member of the first embodiment if the dispersing elements are made of a silicate mineral.

As illustrated in FIG. 5, if the dispersing elements 12 are made of a silicate mineral, silicate crystal layers included in the dispersing elements 12 have negative surface charges, and a liquid that contains water can be adsorbed between the layers. Thus, each of the dispersing elements 12 can draw the liquid 21, adsorbed from the surface of the humidity conditioning elements 11, between the silicate crystal layers. Even after the liquid 21 is drawn between the silicate crystal layers, the silicate crystal layers retain the negative surface charges and repel one other because the silicate crystal layers maintain surface properties that each silicate crystal layer originally has. Hence, the dispersing elements 12 do not aggregate together.

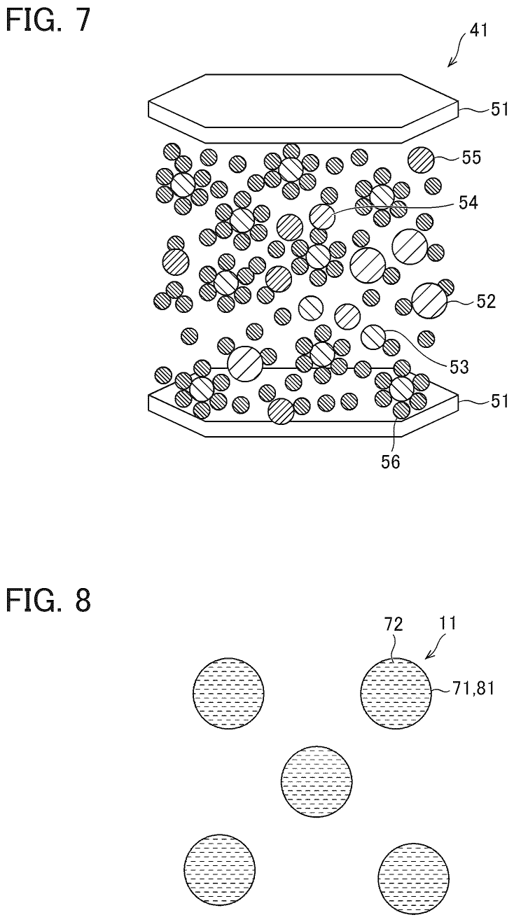

FIG. 6 is a perspective view schematically illustrating a smectite before swelling. The smectite is an example of the silicate mineral forming the dispersing elements included in the humidity conditioning member of the first embodiment. FIG. 7 is a perspective view schematically illustrating a smectite after swelling. The smectite is an example of the silicate mineral forming the dispersing elements included in the humidity conditioning member of the first embodiment.

A smectite 41 illustrated in FIGS. 6 and 7 includes: silicate crystal layers 51; potassium ions 52; sodium ions 53; calcium ions 54; magnesium ions 55; and water molecules 56.

The silicate crystal layers 51 are negatively charged.

The silicate crystal layers 51 are stacked on top of each other. The potassium ions 52, sodium ions 53, the calcium ions 54, the magnesium ions 55, and the water molecules 56 are found between two silicate crystal layers 51 adjacent to each other. Between the silicate crystal layers 51, the water molecules 56 can be injected and removed.

Hence, if each of the dispersing elements 12 is made of the smectite 1, the dispersing element 12 adsorbs the liquid from the surface of the humidity conditioning elements 11.

Furthermore, if each of the dispersing elements 12 is made of the smectite 41, the dispersing elements 12 repel one another because of surface charges produced when the silicate crystal layers 51 are negatively charged. Hence, the dispersing elements 12 do not aggregate together.

### 3.6 Materials of Humidity Conditioning Elements

FIG. 8 is a cross-sectional view schematically illustrating humidity conditioning elements included in the humidity conditioning member of the first embodiment.

As illustrated in FIG. 8, each of the humidity conditioning elements 11 includes: a water absorbent 71; and a humidity conditioning component 72. The water absorbent 71 is made of a water absorbing material 81. The water absorbent 71 may contain an element other than the water absorbing material 81. The humidity conditioning component 72 is contained in the water absorbing material 81. The humidity conditioning component 72 either absorbs or releases water. The humidity conditioning component 72 contains a deliquescent component. The humidity conditioning element 11 is produced of the water absorbent 71 impregnated with a liquid that contains the humidity conditioning component 72.

The water absorbing material 81 contains at least one selected from the group consisting of, for example, a water absorbing resin and a clay mineral.

The water absorbing resin may be either an ionic resin or a non-ionic resin. The water absorbing resin is either granular or particulate.

The ionic resin contains at least one selected from the group consisting of, for example, alkali metal salt of polyacrylic acid and starch-acrylate graft polymer. The alkali metal salt of polyacrylic acid contains, for example, sodium polyacrylate.

The non-ionic resin contains at least one selected from the group consisting of, for example, a vinyl acetate copolymer, a maleic anhydride copolymer, polyvinyl alcohol, and polyalkylene oxide.

The clay mineral contains at least one selected from the group consisting of, for example, silicate mineral and zeolite. The silicate mineral contains at least one selected from the group consisting of, for example, sepiolite, attapulgite, kaolinite perlite, and dolomite. The humidity conditioning component 72 contains at least one selected from the group consisting of, for example, polyhydric alcohol and salt.

The polyhydric alcohol contains at least one selected from the group consisting of, for example, glycerin, propanediol, butanediol, pentanediol, trimethylolpropane, butanetriol, ethylene glycol, diethylene glycol, triethylene glycol, and lactic acid. The polyhydric alcohol desirably contains a polyhydric alcohol having three or more hydroxyl groups. The polyhydric alcohol having three or more hydroxyl groups contains, for example, glycerin. The polyhydric alcohol may constitute a dimer or a polymer.

Preferably, the salt contains metal salt. More preferably, the salt contains deliquescent metal salt. The salt contains at least one selected from the group consisting of, for example, carboxylate, carbonate, lithium chloride, sodium chloride, potassium chloride, magnesium chloride, calcium chloride, aluminum chloride, zinc chloride, lithium bromide, potassium bromide, calcium bromide, and sodium hydrate. Desirably, the sale contains at least one selected from the group consisting of carboxylate and carbonate.

The carboxylate contains at least one selected from the group consisting of, for example, sodium formate, potassium formate, sodium acetate, potassium acetate, lithium acetate, sodium propionate, potassium propionate, sodium lactate, potassium lactate, and sodium pyrrolidone carboxylate. Desirably, the carboxylate contains at least one selected from the group consisting of sodium formate, sodium acetate, sodium propionate, and sodium lactate.

The carbonate contains at least one selected from the group consisting of, for example, sodium carbonate, potassium carbonate, and calcium carbonate.

Desirably, the deliquescent metal salt contains at least one selected from the group consisting of sodium formate, sodium acetate, sodium propionate, sodium lactate, sodium carbonate and potassium carbonate, all of which are highly safe and hygroscopic.

Each of the humidity conditioning elements 11 may contain at least one selected from the group consisting of a water-containing polymer material, a silicic acid compound material, and diatomaceous earth.

### 3.7 Amount of Water Contained in Humidity Conditioning Elements

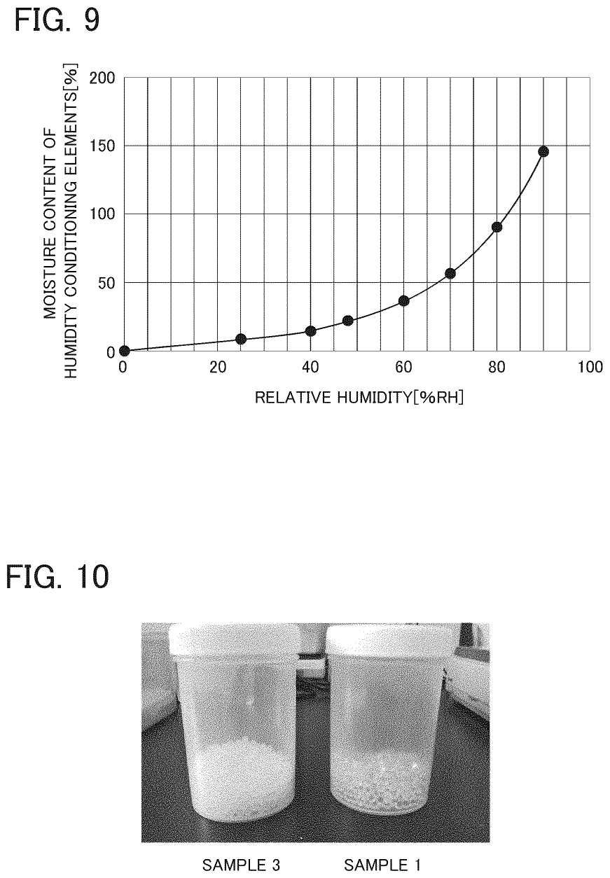

FIG. 9 is a graph showing an example of a moisture absorption isotherm of a water absorbent made of sodium polyacrylate and humidity conditioning elements including a humidity conditioning component made of a glycerin aqueous solution.

In the graph shown in FIG. 9, the horizontal axis represents relative humidity of the ambient air around the humidity conditioning elements 11. Furthermore, the vertical axis represents moisture content of the humidity conditioning elements 11. The moisture content of the humidity conditioning elements 11 is a percentage of water with respect to the humidity conditioning component 72.

As can be understood from FIG. 9, the moisture content of the humidity conditioning elements 11 increases as the target humidity of the humidity conditioning elements 11 increases. For example, if the humidity conditioning elements 11 have a target humidity of 50% RH, the humidity conditioning elements 11 have a moisture content of 25%. If the humidity conditioning elements 11 have a target humidity of 90% RH, the humidity conditioning elements 11 have a moisture content of 146%.

Hence, if the humidity conditioning elements 11 have a target humidity of, for example, as low as 50% RH, the humidity conditioning elements 11 have a moisture content of, for example, as low as 25%. Thus, in the liquid that contains the humidity conditioning component 72 and the water, the concentration of the humidity conditioning component 72 increases. As a result, viscosity of the liquid increases. That is why the humidity conditioning elements 11 could aggregate together. If the target humidity of the humidity conditioning elements 11 is low, the dispersing elements 12 adsorb a portion of the liquid from the surface of the humidity conditioning elements 11 such that the surface properties of the dispersing elements 12 are left. As a result, the dispersing elements 12 reduce adhesion of the humidity conditioning member 1. The dispersing elements 12 serve as a spacer between the humidity conditioning elements 11 and keep the conditioning elements 1 from aggregating together.

Whereas, if the humidity conditioning elements 11 have a target humidity of, for example, as high as 90% RH, the humidity conditioning elements 11 have a moisture content of, for example, as high as 146%. Thus, in the liquid that contains the humidity conditioning component 72 and the water, the concentration of the humidity conditioning component 72 decreases. Hence, viscosity of the liquid decreases. As a result, the humidity conditioning elements 11 do not aggregate together to have fluidity. However, the liquid could seep out of the humidity conditioning elements 11. If the target humidity of the humidity conditioning elements 11 is high, the dispersing elements 12 absorb the liquid from the surface of the humidity conditioning elements 11 and enhance capabilities of the humidity conditioning member 1 to hold water or the liquid. Hence, the dispersing elements 12 keep the liquid from seeping out of the humidity conditioning member 1.

### 3.8 Variation in Adhesion and Dispersion of Humidity Conditioning Member, Depending on Kinds of Dispersing Elements

The humidity conditioning elements 11 were produced to include a water absorbent made of sodium polyacrylate and a humidity conditioning component made of glycerin and water. The humidity conditioning elements had a target humidity of 50% RH.

Sample 1 made of the produced humidity conditioning elements 11 was prepared. Furthermore, dispersing elements shown in Table 1 were added to the prepared humidity conditioning elements 11, and Samples 2 to 6 were prepared. Table 1 shows materials, average particle sizes, addition percentages, and presence or absence of water absorption of the dispersing elements.

TABLE 1

| | Dispersing Element | | | | | |
|---|---|---|---|---|---|---|
| | | Average | | | | |
| | | Particle | Addition | | Fall Time | Angle of |
| | | Size | Rate | Water | Period | Repose |
| Sample | Material | [μm] | [%] | Absorption | [sec.] | [°] |
| Sample 1 | NA | NA | NA | NA | 60< | 50 |
| Sample 2 | Silas Balloon | 7 | 0.6 | Present | <1 | 30 |
| | (Hollow Silica) | | | | | |
| Sample 3 | Silicate Mineral | 7 | 1.8 | Present | <1 | 30 |
| Sample 4 | Spherical | <5 | 1.2 | Absent | <1 | 32 |
| | Polymethyl | | | | | |
| | Methacrylate | | | | | |
| | Resin | | | | | |
| Sample 5 | Spherical | 4 | 1.2 | Absent | <1 | 32 |
| | Polystyrene | | | | | |
| | Resin | | | | | |
| Sample 6 | Sodium | 200-300 | 5.0 | Present | <1 | 50< |
| | Polyacrylate | | | | | |

The prepared Samples 1 to 6 were evaluated for adhesion and dispersion.

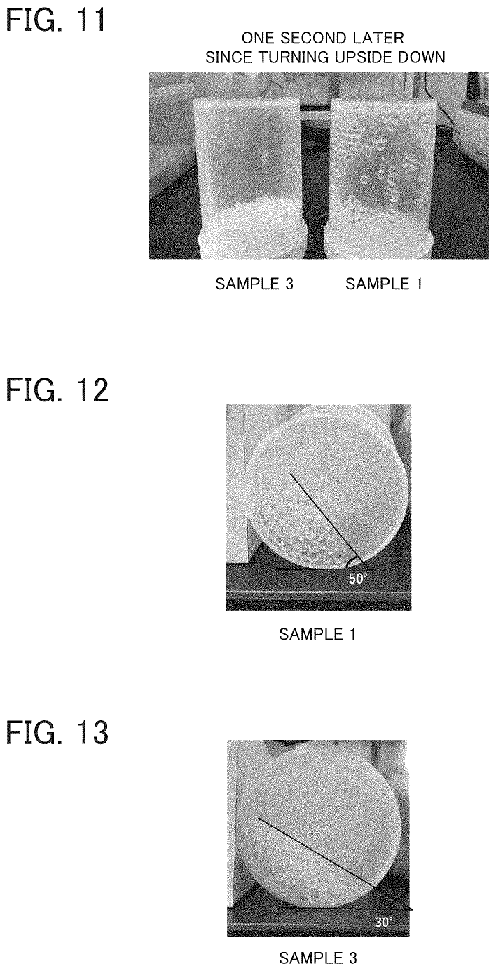

FIGS. 10 and 11 are images showing how to evaluate adhesion of Samples 1 to 6.

As to the evaluation of adhesion for the samples, each of the samples that weighed 50 g was stored in a plastic container having a cylindrical outer shape and an inner volume of 300 ml. Next, as shown in FIG. 10, the plastic containers were placed on the surface so that the axial direction of the plastic containers was vertically oriented. Next, as shown in FIG. 11, the plastic containers were turned upside down. Then, time periods required for all the samples to fall were measured. Table 1 shows the measured fall time periods. In the measurement, a long fall time period means that the sample is highly adhesive.

FIGS. 12 and 13 are images showing how to evaluate dispersion of Samples 1 to 6.

As to the evaluation of dispersion for the samples, each of the samples that weighed 50 g was stored in a plastic container having a cylindrical outer shape and an inner volume of 300 ml. Next, the plastic containers were placed on the surface so that the axial direction of the plastic containers was horizontally oriented. Next, as shown in FIGS. 12 and 13, the plastic containers were rolled circumferentially on the surface. Then, an angle of repose between the horizontal plane and the slope formed by the stationary sample was measured. Table 1 shows the measured angles of repose. In the measurement, a low angle of repose means that the sample is highly dispersive.

As shown in Table 1, the fall time period of Sample 1 with no dispersing element added was longer than 60 seconds. As to Samples 2, 3, 4, 5 and 6 to which silas balloons, a silicate mineral, a spherical polymethyl methacrylate resin, a spherical polystyrene resin, and sodium polyacrylate were respectively added, the fall time periods of these samples were shorter than one second. As can be seen, the silas balloons, the silicate mineral, the spherical polymethyl methacrylate resin, the spherical polystyrene resin, or the sodium polyacrylate added to the humidity conditioning elements 11 can reduce the adhesion of the humidity conditioning members. Here, when sodium polyacrylate is added to the humidity conditioning elements 11, the fall time period is short. However, the short fall time period is a result that the whole humidity conditioning elements 11 aggregate together and fall. It does not mean that the adhesion of the humidity conditioning member has decreased.

Furthermore, as shown in Table 1, the angle of repose of Sample 1 with no dispersing element added was 50°. As to the Samples 2 and 3 to which the silas balloons and the silicate mineral were respectively added, the angles of repose were 30°. As to Samples 4 and 5 to which the spherical polymethyl methacrylate resin and the spherical polystyrene resin were respectively added, the angles of repose were 32°. The angle of repose of Sample 6 with sodium polyacrylate added was higher than 50°. As can be seen, the silas balloons, the silicate mineral, the spherical polymethyl methacrylate resin, the spherical polystyrene resin, or the sodium polyacrylate added to the humidity conditioning elements 11 can enhance the dispersion of the humidity conditioning members. Furthermore, as can be seen, the sodium polyacrylate added to the humidity conditioning elements 11 reduces the dispersion of the humidity conditioning members. This is because, when the sodium polyacrylate absorbs the liquid from the surface of the humidity conditioning material 11, the sodium polyacrylate does not confine therein the liquid such that the liquid is found on, and covers, the entire surface. Hence, the humidity conditioning material does not show any improvement in adhesion. That is, it is important to understand that the adhesion depends not on the particle size of, or presence or absence of water absorption of, the dispersing elements, but on the dispersing elements that adsorb a portion of the liquid from the surface of the humidity conditioning elements 11.

3.9 Variation in Seepage of Liquid from Humidity Conditioning Member, Depending on Kinds of Dispersing Elements

The humidity conditioning elements 11 were produced to include a water absorbent made of sodium polyacrylate and a humidity conditioning component made of glycerin. The humidity conditioning elements 11 had a target humidity of 90% RH.

Sample 1 made of the produced humidity conditioning elements 11 was prepared. Furthermore, dispersing elements shown in Table 2 were added to the prepared humidity conditioning elements 11, and Samples 2 to 5 were prepared. Table 2 shows materials, average particle sizes, addition percentages, and presence or absence of water absorption of the dispersing elements.

TABLE 2

| | Dispersing Element | | | | |
|---|---|---|---|---|---|
| | | Average | | | |
| | | Particle | Addition | | Presence or Absence of |
| | | Size | Rate | Water | Stains on Water- |
| Sample | Material | [μm] | [%] | Absorption | Absorbing Paper |
| Sample 1 | NA | NA | NA | NA | Present |
| Sample 2 | Silas Balloon | 7 | 0.6 | Present | Absent |
| | (Hollow Silica) | | | | |
| Sample 3 | Silicate Mineral | 7 | 1.8 | Present | Absent |
| Sample 4 | Spherical | <5 | 1.2 | Absent | Present |
| | Polymethyl | | | | |
| | Methacrylate | | | | |
| | Resin | | | | |
| Sample 5 | Spherical | 4 | 1.2 | Absent | Present |
| | Polystyrene | | | | |
| | Resin | | | | |

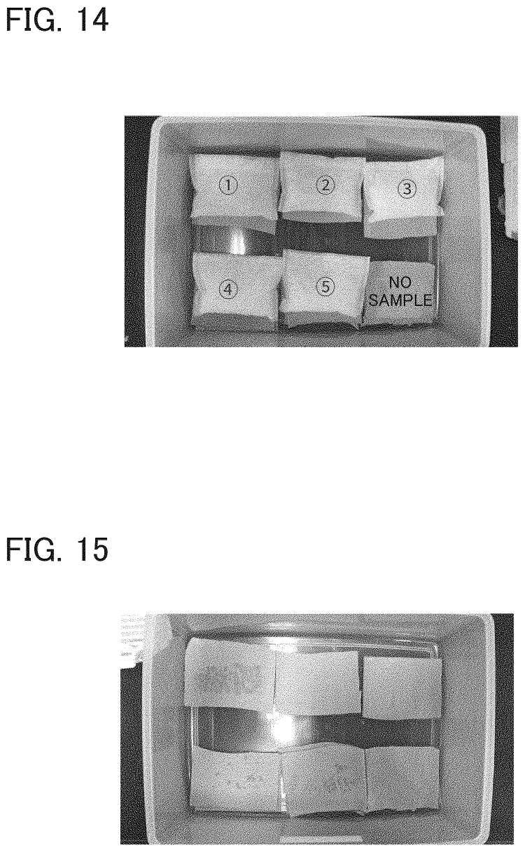

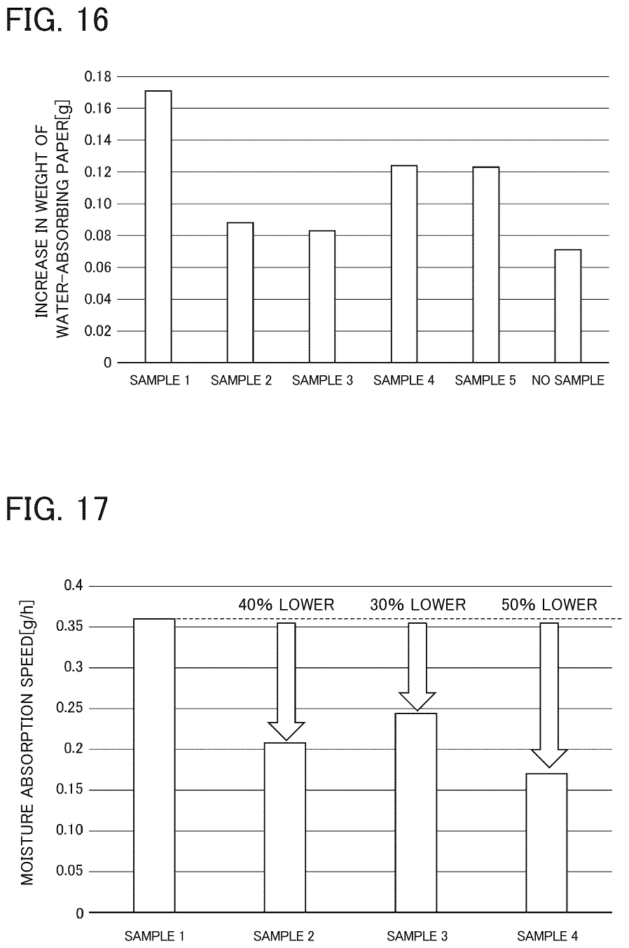

FIGS. 14 and 15 are images showing how to evaluate presence or absence of the liquid seeping out of Samples 1 to 5. FIG. 16 is a graph showing an increase in weight of water-absorbing paper since before bags that contain Samples 1 to 5 are put still on the water-absorbing paper. In FIG. 16, the horizontal axis represents kinds of the samples. Furthermore, the vertical axis represents increase in the weight of the water-absorbing paper.

Evaluation was made for presence or absence of the liquid seeping out of Samples 1 to 5.

As to the evaluation of the presence or absence of the liquid seeping out of the samples, each of the samples was contained in a bag made of a nonwoven fabric that can be used as a breathable packing material. Hence, the samples were prepared as bagged samples. The bags are “Ochadashi Pack Ultra Thin Type (Ultra-Thin Tea Bags)” manufactured by Zenmi Co., Ltd. The bags are made of polyester and polyethylene. Then, as shown in FIG. 14, the bagged samples were placed still on water-absorbing paper put on an inner bottom surface of a container. The container was covered with a lid. The samples were set still on the water-absorbing paper for six hours. After that, as shown in FIG. 15, the lid was removed from the container and the bagged samples were removed from the water-absorbing paper. Next, the water-absorbing paper was checked for presence or absence of a stain made when the liquid seeped out of the samples. Table 2 shows presence or absence of stains on the checked water-absorbing paper. Furthermore, an increase in weight of the water-absorbing paper was measured since before bagged samples had been put still on the water-absorbing paper. FIG. 16 shows an increase in the weight of the measured water-absorbing paper. FIG. 16 shows an increase in the weight of the water-absorbing paper absorbing moisture when no bagged sample was put still on the water-absorbing paper (i.e., no sample). The presence of a stain on the water-absorbing paper or a large increase in the weight of the water-absorbing paper indicates that the liquid has seeped out of the sample. That is, if no stain is present on the water-absorbing paper or an increase in the weight of the water-absorbing paper is small, the dispersing elements contained in a sample keep the liquid from seeping out of the sample.

As shown in Table 2, a stain was found on the water-absorbing paper on which a bagged sample of Sample 1 was put still. Sample 1 contained no dispersing element. No stain was found on the water-absorbing paper on which bagged samples of Sample 2 and Sample 3 were put still. Sample 2 and Sample 3 respectively contained silas balloons and a silicate mineral. Stains were found on the water-absorbing paper on which bagged sample of Sample 4 and Sample 5 were put still. Sample 4 and Sample 5 respectively contained a spherical polymethyl methacrylate resin and a spherical polystyrene resin. Furthermore, as shown in FIG. 16, an increase in the weight of the water-absorbing paper, on which the bagged sample of Sample 1 without dispersing elements was put still, was significantly greater than an increase in the weight of the water-absorbing paper on which no bagged sample was put still. An increase in the weight of the water-absorbing paper, on which the bagged samples of Sample 2 and Sample 3 respectively containing the silas balloons and the silicate mineral were put still, was only slightly greater than an increase in the weight of the water-absorbing paper on which no bagged sample was put still. An increase in the weight of the water-absorbing paper, on which the bagged samples of Sample 4 and Sample 5 respectively containing the spherical polymethyl methacrylate resin and the spherical polystyrene resin were put still, was significantly greater than an increase in the weight of the water-absorbing paper on which no bagged sample was put still. As can be seen, when the silas balloons or the silicate mineral is added to the humidity conditioning elements 11, the dispersing elements adsorb the liquid from the humidity conditioning member so as to successfully reduce the risks that the liquid seeps out of a sample and a packing material leaks the liquid.

### 3.10 Variation in Humidity Conditioning Speeds of Humidity Conditioning Member, Depending on Kinds of Dispersing Elements

The humidity conditioning elements 11 were produced to include a water absorbent made of sodium polyacrylate and a humidity conditioning component made of glycerin. The humidity conditioning elements 11 had a target humidity of 50% RH.

Sample 1 made of the produced humidity conditioning elements 11 was prepared. Furthermore, dispersing elements shown in Table 3 were added to the prepared humidity conditioning elements 11, and Samples 2 to 4 were prepared. Table 3 shows materials, average particle sizes, addition percentages, and presence or absence of water absorption of the dispersing elements.

TABLE 3

| | Dispersing Element | | | |
|---|---|---|---|---|
| | | Average | | |
| | | Particle | Addition | |
| | | Size | Rate | Water |
| Sample | Material | [μm] | [%] | Absorption |
| Sample 1 | NA | NA | NA | NA |
| Sample 2 | Silas Balloon (Hollow | 7 | 0.6 | Present |
| | Silica) | | | |
| Sample 3 | Silicate Mineral | 7 | 1.8 | Present |
| Sample 4 | Spherical Polymethyl | <5 | 1.2 | Absent |
| | Methacrylate Resin | | | |

The prepared Samples 1 to 4 were evaluated for moisture absorption speed.

FIG. 17 is a graph showing moisture absorption speeds of Samples 1 to 4.

In FIG. 17, the horizontal axis represents kinds of the samples. Furthermore, the vertical axis represents moisture absorption speed of the samples.

In evaluating a moisture absorption speed of a sample, the sample was set still for 30 minutes in a bath at a constant temperature of 23° C. and a constant humidity of 70% RH. Next, measured was an increase in weight of the sample between before and after the sample was put in the bath at constant temperature and humidity. Furthermore, a moisture absorption speed of the sample was calculated from the measured increase in the weight of the sample. FIG. 17 shows calculated moisture absorption speeds of the samples.

As shown in FIG. 17, a moisture absorption speed of Sample 2 to which silas balloons were added was 40% lower than a moisture absorption speed of Sample 1 with no dispersing element added. Furthermore, a moisture absorption speed of Sample 3 to which a silicate mineral was added was 30% lower than the moisture absorption speed of Sample 1 with no dispersing element added. A moisture absorption speed of Sample 4 to which a spherical polymethyl methacrylate resin was added was 50% lower than the moisture absorption speed of Sample 1 with no dispersing element added. As can be seen, a decrease in the moisture absorption speed of each of Sample 2 and Sample 3, to which the silas balloons and the silicate mineral were added, is smaller than a decrease in the moisture absorption speed of Sample 4 to which the spherical polymethyl methacrylate resin was added. The reason why the decrease in the moisture absorption speed of each of Samples 2 and 3 is relatively small is probably because the silas balloons and the silicate mineral themselves absorb the liquid and serve as humidity conditioning materials.

### 3.11 Kinds of Desirable Dispersing Elements

The results of the above evaluations show that the silas balloons or the silicate mineral added to the humidity conditioning elements 11 can reduce adhesion of, and enhance dispersion of, the humidity conditioning member. That is, the humidity conditioning member can be kept from aggregating together. Furthermore, as can be seen, the silas balloons or the silicate mineral added to the humidity conditioning elements 11 can keep the liquid from seeping out of the humidity conditioning member. Furthermore, as can be seen, the silas balloons or the silicate mineral added to the humidity conditioning elements 11 does not significantly slow the humidity conditioning speed. Hence, when the silas balloons or the silicate mineral is added to the humidity conditioning elements 11, the humidity conditioning material, which contains a liquid made of a humidity conditioning component and water, suffers only a small decrease in humidity conditioning function. In addition, the humidity conditioning elements 11 successfully improve in fluidity, and, simultaneously, the liquid can be kept from seeping out of the humidity conditioning material.

### 4 Second Embodiment

Described below will be how a second embodiment is different from the first embodiment. Otherwise, the same configurations as those employed in the first embodiment are also employed in the second embodiment.

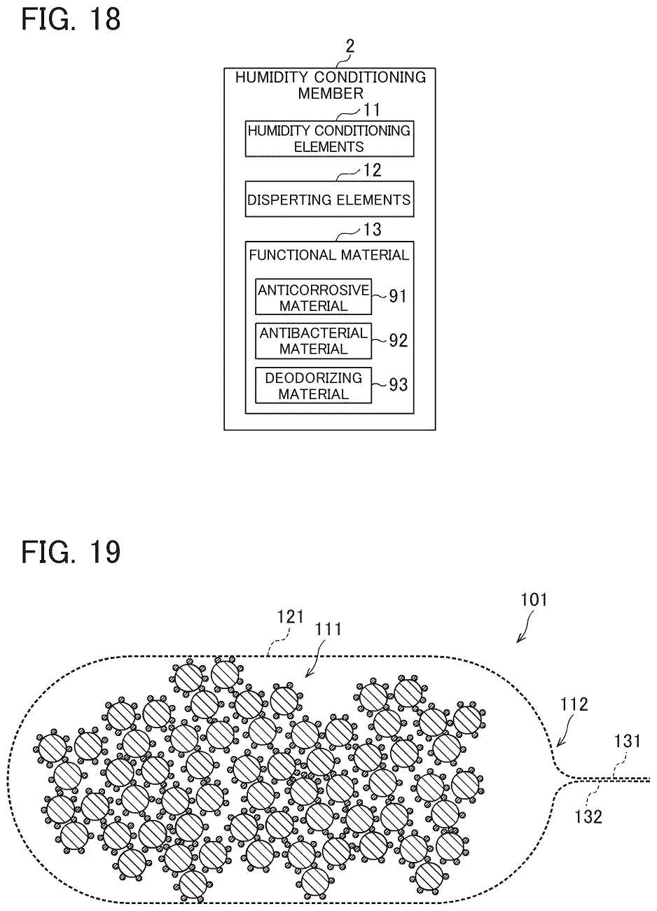

FIG. 18 schematically illustrates components of a humidity conditioning member of the second embodiment.

Similar to the humidity conditioning member 1 of the first embodiment, a humidity conditioning member 2 of the second embodiment includes: the humidity conditioning elements 11; and the dispersing elements 12. Furthermore, unlike the humidity conditioning member 1, the humidity conditioning member 2 includes a functional member 13.

The humidity conditioning elements 11, the dispersing elements 12, and the functional material 13 are mixed together. The functional material 13 provides the humidity conditioning member 2 with a function other than the humidity conditioning function.

The functional material 13 contains at least one selected from the group consisting of an anticorrosive material 91, an antibacterial material 92, and a deodorizing material 93.

The anticorrosive material 91 provides an anticorrosive function to the humidity conditioning member 2. The anticorrosive function provided to the humidity conditioning member 2 can keep a metal material adjacent to the humidity conditioning member 2 from rust. Such a feature makes the humidity conditioning member 2 suitable when a metal member is stored. The anticorrosive material 91 contains at least one selected from the group consisting of, for example, amine carboxylate, molybdate, chromate, silicate, zinc, and organic silicate. The organic silicate contains at least one selected from the group consisting of, for example, an organosilane-containing resin and ethyl silicate.

The antibacterial material 92 provides an antibacterial function to the humidity conditioning member 2. The antibacterial function provided to the humidity conditioning member 2 can keep, for example, medical and food products adjacent to the humidity conditioning member 2 from decay and mold. Such a feature makes the humidity conditioning member 2 suitable when the medical products are stored and the food products are kept fresh. The antibacterial material 92 contains at least one selected from the group consisting of, for example, an organic antibacterial material, an inorganic antibacterial material, and a natural antibacterial material. The inorganic antibacterial material releases at least one selected from the group consisting of, for example, silver ions and zinc ions. The natural antibacterial material contains a natural ingredient. The natural ingredient contains at least one selected from the group consisting of a biologically derived extract and xatone.

The deodorizing material 93 provides a deodorizing function to the humidity conditioning member 2. The deodorizing function provided to the humidity conditioning member 2 can remove odor of, for example, medical and food products adjacent to the humidity conditioning member 2. Such a feature makes the humidity conditioning member 2 suitable when the medical products are stored and the food products are kept fresh. The deodorizing material 93 includes, for example, activated carbon powder.

### 5 Third Embodiment

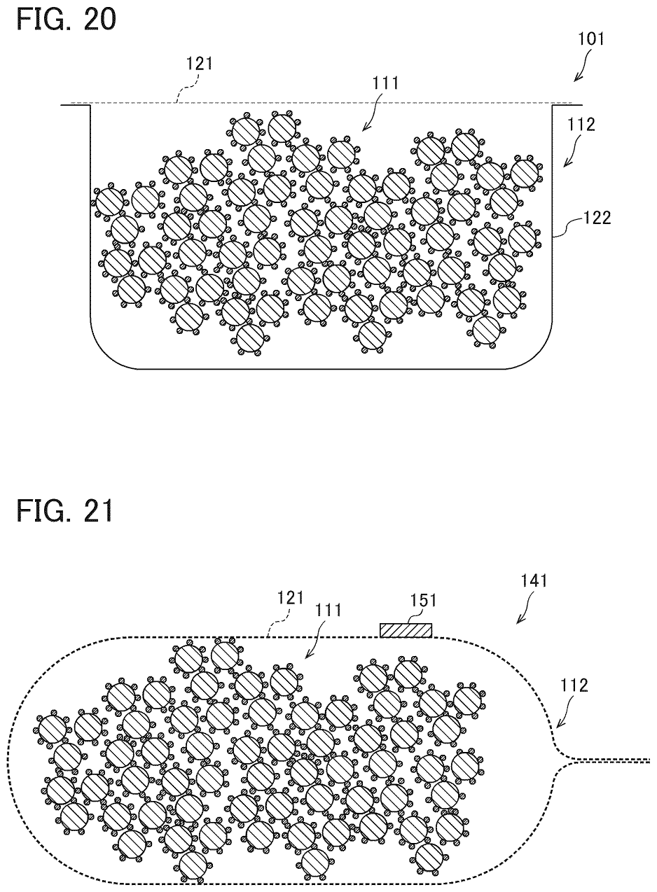

FIG. 19 is a cross-sectional view schematically illustrating a packed humidity conditioning member in a first example of a third embodiment. FIG. 20 is a cross-sectional view schematically illustrating a packed humidity conditioning member in a second example of the third embodiment.

As illustrated in FIGS. 19 and 20, the packed humidity conditioning member 101 includes: a humidity conditioning member 111; and a packing material 112.

The humidity conditioning member 111 is the humidity conditioning member 1 of the first embodiment or the humidity conditioning member 2 of the second embodiment.

The packing material 112 packages the humidity conditioning member 111. The packing material 112 is breathable. The packing material 112 can keep the humidity conditioning member 111 from directly making contact with a humidity conditioned target, and, simultaneously, allows the humidity conditioning member 111 to condition humidity for the humidity conditioned target.

In the first example of the third embodiment, the packing material 112 includes a breathable packing material 121. The breathable packing material 121 is flexible and shaped in sheet form. The breathable packing material 121 has a first end portion 131 and a second end portion folded to overlap with each other. The overlapping first end portion 131 and second end portion 132 are bonded together. The bonding involves, for example, fusing by heat-sealing. Thus, the packing material 112 is shaped into a pouch shape. Hence, the packing material 112 can contain the humidity conditioning member 111.

In the second example of the third embodiment, the packing material 112 includes: the breathable packing material 121; and a plastic container 122. The plastic container 122 has a certain shape. The plastic container 122 has an opening. The breathable packing material 121 seals the opening. Hence, the packing material 112 can contain the humidity conditioning member 111.

The packing material 112 may be partially transparent. Hence, a user can observe from outside a condition of the humidity conditioning member 111 contained in the packing material 112.

The breathable packing material 121 has ventilating holes. A ventilating hole is smaller in size than a humidity conditioning element 11. Such a feature makes it possible to block the humidity conditioning elements 11, and the dispersing elements 12 attached to the surface of the humidity conditioning elements 11, from passing through the breathable packing material 121. As long as a ventilating hole is smaller in size than a humidity conditioning element 11, the packing material 112 may have a mesh structure of the order of millimeters. Desirably, a ventilating hole is smaller in size than a dispersing element 12. Such a feature makes it possible to block the dispersing elements 12 from passing through the breathable packing material 121.

In order to produce the packed humidity conditioning member 101, the humidity conditioning member 111 has to receive a secondary treatment such as packaging the humidity conditioning member 111 into the packing material 112 using such an apparatus as an automated filling and packaging apparatus. Whereas, the dispersing elements 12 keep the humidity conditioning member 111 from aggregating together, and it is easy to give the humidity conditioning member 111 the secondary treatment. Hence, the packed humidity conditioning member 101 can be easily produced. The same applies to a case where the secondary treatment other than filling and packaging, which is, for example, stirring and mixing with another material, is required to be given in order to produce a product including the humidity conditioning member 111.

### 6 Fourth Embodiment

Described below will be how a fourth embodiment is different from the third embodiment. Otherwise, the same configurations as those employed in the third embodiment are also employed in the fourth embodiment.

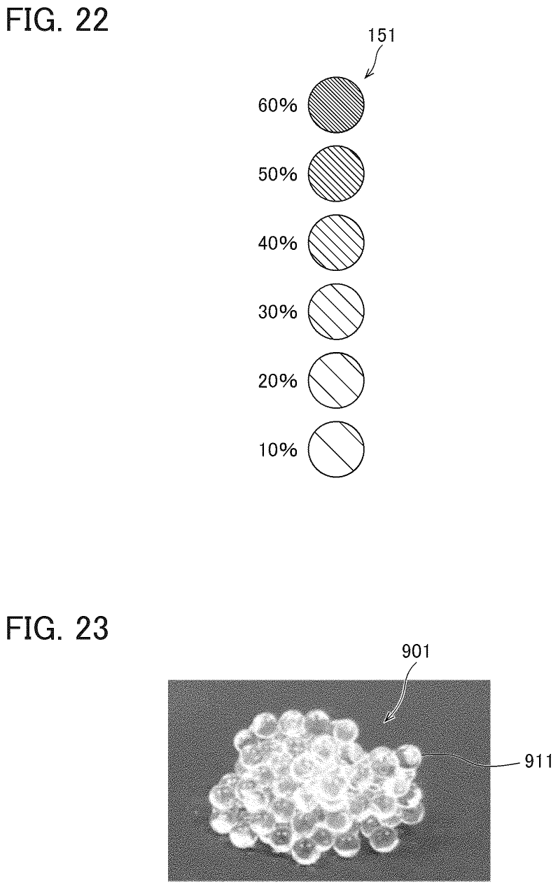

FIG. 21 is a cross-sectional view schematically illustrating a packed humidity conditioning member of the fourth embodiment. FIG. 22 shows color change of an indication label included in the packed humidity conditioning member of the fourth embodiment.

As illustrated in FIG. 21, a packed humidity conditioning member 141 of the fourth embodiment includes an indication label 151.

The indication label 151 is disposed on the breathable packing material 121. The indication label 151 is disposed in a region included in a surface of the breathable packing material 121. The indication label 151 presents a color based on humidity. The indication label 151 changes in color when an equilibrium humidity of the humidity conditioning member 111 is off around a target humidity of the humidity conditioning member 111. When the equilibrium humidity of the humidity conditioning member 111 is off around the target humidity of the humidity conditioning member 111, such a feature can encourage the user to replace the humidity conditioning member 111 with a new humidity conditioning member 111 and to refurbish the humidity conditioning member 111.

The indication label 151 contains an indication material whose color changes in accordance with humidity. The indication material contains at least one selected from the group consisting of, for example, cobalt chloride, cobalt bromide, phthalein dye, and a compound of polymerized triphenylmethane dye such as phthalein dye.

The present disclosure shall not be limited to the above-described embodiments, and may be replaced with a configuration substantially the same as a configuration having the same advantageous effects as, or a configuration capable of achieving the same object as, the configurations described in the above-described embodiments.

1. A humidity conditioning member, comprising:
a plurality of humidity conditioning elements having a surface and containing a liquid either absorbing or releasing water; and
a plurality of dispersing elements having an average particle size smaller than an average particle size of the plurality of humidity conditioning elements, adhering to the surface, adsorbing a portion of the liquid from the surface, and dispersing the plurality of humidity conditioning elements.

2. The humidity conditioning member according to claim 1,
wherein the plurality of humidity conditioning elements has an average particle size of 0.1 mm or more and 10 mm or less, and
the plurality of dispersing elements has an average particle size of 1 μm or more and 100 μm or less.

3. The humidity conditioning member according to claim 2,
wherein the plurality of dispersing elements contains at least one selected from the group consisting of silicon dioxide and a silicate compound.

4. The humidity conditioning member according to claim 3,
wherein the plurality of dispersing elements contains at least one selected from the group consisting of silas and a silicate mineral.

5. The humidity conditioning member according to claim 4,
wherein each of the plurality of dispersing elements has a hole formed inside the dispersing element.

6. The humidity conditioning member according to claim 1,
wherein each of the plurality of humidity conditioning elements includes:
a water absorbent containing a water absorbing material; and
a humidity conditioning component contained in the water absorbing material and either absorbing or releasing water, and
the liquid is made of the humidity conditioning component and water.

7. The humidity conditioning member according to claim 6,
wherein the humidity conditioning component contains at least one selected from the group consisting of polyhydric alcohol and salt.

8. The humidity conditioning member according to claim 7,
wherein the salt contains metal salt.

9. The humidity conditioning member according to claim 8,
wherein the salt contains at least one selected from the group consisting of carboxylate and carbonate.

10. The humidity conditioning member according to claim 6,
wherein the water absorbing material contains at least one selected from the group consisting of a water absorbing resin and a clay mineral.

11. The humidity conditioning member according to claim 1, further comprising
at least one selected from the group consisting of an anticorrosive material, an antibacterial material, and a deodorizing material.

12. The humidity conditioning member according to claim 1,
wherein each of the plurality of dispersing elements has a hole formed inside the dispersing element.

13. A packed humidity conditioning member, comprising:
the humidity conditioning member according to claim 1; and
a packing material packaging the humidity conditioning member and being breathable.

14. The packed humidity conditioning member according to claim 13, further comprising
an indication label disposed on the packing material and presenting a color based on humidity.
